(19) United States
(12) Patent Application Publication
(10) Pub. No.: US 2004/0205482 A1
(43) Pub. Date: Oct. 14, 2004

(54) Method and apparatus for active annotation of multimedia content

(75) Inventors: Sankar Basu, Tenafly, NJ (US); Ching-Yung Lin, Yonkers, NY (US); Milind R. Naphade, Urbana, IL (US); John R. Smith, New Hyde Park, NY (US); Belle L. Tseng, Forest Hills, NY (US)

Correspondence Address: IBM CORPORATION, INTELLECTUAL PROPERTY LAW DEPT., P.O. BOX 218, YORKTOWN HEIGHTS, NY, 10598, US

(73) Assignee: International Business Machines Corporation, Armonk, NY (US)

(21) Appl. No.: 10/056,546

(22) Filed: Jan. 24, 2002

(51) Int. Cl. G06F 17/24

(52) U.S. Cl. 715/500.1; 715/512

(57) ABSTRACT

Semantic indexing and retrieval of multimedia content requires that the content is sufficiently annotated. However, the great volumes of multimedia data and diversity of labels make annotation a difficult and costly process. Disclosed is an annotation framework in which supervised training with partially labeled data is facilitated using active learning. The system trains a classifier with a small set of labeled data and subsequently updates the classifier by selecting a subset of the available data-set according to optimization criteria. The process results in propagation of labels to unlabeled data and greatly facilitates the user in annotating large amounts of multimedia content.

### FIELD OF THE INVENTION

The present invention relates to the efficient interactive annotation or labeling of unlabeled data. In particular, it relates to active annotation of multimedia content, where the annotation labels can facilitate effective searching, filtering, and usage of content. The present invention relates to a proactive role of the computer in assisting the human annotator in order to minimize human effort

### DISCUSSION OF THE PRIOR ART

Accessing multimedia content at a semantic level is essential for efficient utilization of content. Studies reveal that most queries to content-based retrieval systems are phrased in terms of keywords. To support exhaustive indexing of content using such semantic labels, it is necessary to annotate the multimedia databases. While manual annotation is being used currently, automation of this process to some extent can greatly reduce the burden of annotating large databases.

In supervised learning, the task is to design a classifier when the sample data-set is completely labeled. In situations where there is an abundance of data but labeling is too expensive in terms of money or user time, the strategy of active learning can be adopted. In this approach, one trains a classifier based only on a selected subset of the labeled data-set. Based on the current state of the classifier, one selects some of the “most informative” subset of the unlabeled data so that knowing labels of the selected data is likely to greatly enhance the design of the classifier. The selected data is to be labeled by a human or an oracle, and be added to the training set. This procedure can be repeated, and the goal is to label as little data as possible to achieve a certain performance. The approach of boosting classification performance without labeling a large data set has been previously studied. Methods of active learning can improve classification performance by labeling uncertain data, as taught by David A. Cohn, Zhoubin Ghahramani and Michael I. Jordan in “Active learning with statistical models, ” Journal of Artificial Intelligence Research (4), 1996, 129-145, and Vijay Iyengar, Chid Apte, and Tong Zhang in “Active Learning Using Adaptive Resampling, ” ACM SIGKDD 2000. It may be remarked in this context that the larger problem of using unlabelled data to enhance classifier performance, of which active learning can be viewed as a specific solution, can also be alternatively approached via other passive learning techniques. For example, methods using unlabelled data for improving classifier performance were taught by M. R. Naphade, X. Zhou, and T. S. Huang in “Image classification using a set of labeled and unlabeled images,” Proceedings of SPIE Photonics East, Internet Multimedia Management Systems, November, 2000. The effect of unlabeled samples in reducing the small sample size problem and mitigating the Hughes phenomenon was taught by B. Shahshahani and D. Landgrebe in IEEE Transactions on Geoscience and Remote Sensing, 32, 1087-1095, 1994.

Active learning strategies can be broadly classified into three different categories. One approach to active learning is “uncertainty sampling,” in which instances in the data that need to be labeled are iteratively identified based on some measure that suggests that the predicted labels for these instances are uncertain. A variety of methods for measuring uncertainty can be used. For example, a single classifier can be used that produces an estimate of the degree of uncertainty in its prediction and an iterative process can then select some fixed number of instances with maximum estimated uncertainty for labeling. The newly labeled instances are then to be added to the training set and a classifier generated using this larger training set. This iterative process is continued until the training set reaches a specified size. This method can be further generalized by more than one classifier. For example, one classifier can determine the degree of uncertainty and another classifier can perform classification.

An alternative, but related, approach is sometimes referred to as “Query by Committee.” Here, two different classifiers consistent with the already labeled training data are randomly chosen. Instances of the data for which the two chosen classifiers disagree are then candidates for labeling. As an example of “adaptive resampling,” methods are being increasingly used to solve the classification problem in various domains with high accuracy.

A third strategy to active learning is to exploit such techniques. Vijay Iyengar, Chid Apte, and Tong Zhang in “Active Learning Using Adaptive Resampling, ” ACM SIGKDD 2000, taught a method for a boosting-like technique that “adaptively resamples” data biased towards the misclassified points in the training set and then combines the predictions of several classifiers.

Even among the uncertainty sampling methods a variety of classifiers and measures of degree of uncertainty of classification can be used. Two specific classifiers suited for this purpose are the Support Vector Machine (SVM) and gaussian Mixture Model (GMM).

SVMs can be used for solving many different pattern classification problems, as taught by V. Vapnik in Statistical Learning Theory, Wiley, 1998, and N. Cristianini and J. Shawe-Taylor in An Introduction to Support Vector Machines and other Kernel-Based Learning Methods, Cambridge University Press, 2000. For SVM classifiers the distance of an unlabeled data-point from the separating hyperplane in the high dimensional feature space could be taken as a measure of uncertainty (alternatively, a measure of confidence in classification) of the data-point. A method for using an SVM classifier in the context of relevance feedback searching for video content was taught by Simon Tong and Edward Chang in “Support Vector Machine Active Learning for Image Retrieval,” ACM Multimedia, 2001. A method for using an SVM classifier for text classification was taught by S. Tong and D. Koller in “Support vector machine active learning with applications to text classification,” Proceedings of the 17th International Conference on Machine Learning, pages 401-412, June 2000.

For a GMM classifier the likelihood of the new data-point given the current parameters of the GMM can be used as a measure of this confidence. A method for using a GMM in active learning was taught by David A. Cohn, Zhoubin Ghahramani, and Michael I. Jordan in “Active learning with statistical models, ” Journal of artificial intelligence research (4), 1996, 129-145.

A method for annotating spatial regions of images that combines low level textures with high level descriptions to assist users in the annotation process was taught by Picard and T. P. Minka in “Vision texture for annotation,” MIT Media Laboratory Perceptual Computing Section Technical Report No. 302, 1995 The system dynamically selects multiple texture models based on the behavior of the user in selecting a region for labeling. A characteristic feature of this work is that it uses trees of clusters as internal representations which make it flexible enough to allow combinations of clusters from different models. If no one model was the best then it could produce a new hypothesis by pruning and merging relevant pieces from the model tree. The technique did not make use of a similarity metric during annotation: the metrics were used only to cluster the patches into a hierarchy of trees, allowing fast tree search and permitting online comparison among multiple models.

A method for retrieving images using relevance feedback was taught by Simon Tong and Edward Chang in “Support Vector Machine Active Learning for Image Retrieval,” ACM Multimedia 2001. The objective of the system is image retrieval and not the generation of persistent or stored annotations of the image content. As a result, the problem of annotating large amounts of multimedia content using active learning methods has not been addressed.

Therefore, a need exists for a system and method for facilitating the efficient annotation of large volumes of multimedia content such as video databases and image archives.

### SUMMARY OF THE INVENTION

It is, therefore, an objective of the present invention to provide a method and apparatus for supervised and semi-supervised learning to aid the active annotation of multimedia content. The active annotation system includes an active learning component that prompts the user to label a small set of selected example content that allows the labels to be propagated with given confidence levels. Thus, by allowing the user to interact with only a small subset of the data, the system facilitates efficient annotation of large amounts of multimedia content. The system builds spatio-temporal multimodal representations of semantic classes. These representations are then used to aid the annotation through smart propagation of labels to content similar in terms of the representation.

It is another objective of the invention to use the active annotation system in creating labeled multimedia content with crude models of semantics that can be further refined off-line to build efficient and accurate models of semantic concepts using supervised training methods. Different types of relationships can be used to assist the use, such as spatio-temporal similarity, temporal proximity, and semantic proximity. Spatio-temporal similarity between regions or blobs of image sequences can be used to cluster the blobs in the videos before the annotation task begins. For example, as the user starts annotating the video database, the learning component of the system will attempt to propagate user-provided labels to regions with similar spatio-temporal characteristics. Furthermore, the temporal proximity and the co-occurrence of user-provided labels for the videos (e.g.) seen by the user can be used to suggest labels for the videos the user is annotating.

### BRIEF DESCRIPTION OF THE DRAWINGS

The invention will hereinafter be described in greater detail with specific reference to the appended drawings wherein:

FIG. 1 depicts a system that actively selects examples to be annotated, accepts annotations for these examples from the user and propagates and stores these annotations. This figure illustrates the active annotation system where the system selects those examples to be annotated by the user that result in maximal disambiguation and causes the user to annotate as few examples as possible, and then automatically propagates annotations to the unlabeled examples.

FIG. 2 depicts active selection returning one or more examples. This figure shows the system performing active selection. The selection is done by using existing internal or external representations of the annotations in the lexicon.

FIG. 3 shows using ambiguity as a criterion for selection. The system minimizes the number of examples that the user needs to annotate by selecting only those examples which are most ambiguous. Annotating these examples thus leads to maximal disambiguation and results in maximum confidence for the system to propagate the annotations automatically. The selected examples are thus the most “informative” examples in some sense.

FIG. 4 depicts the system accepting annotations from the vocabulary. The user provides annotation from the vocabulary, which can be adaptively updated. Multimodal human computer interaction assists the user in communicating with the system. The vocabulary can be modified adaptively by the system and/or the user. Multimodal human computer intelligent interaction can reduce the burden of user interaction. This is done through detection of the user's face movement, gaze and/or finger. Speech recognition can also be used for verifying propagated annotations. The user can respond to such questions as: “Is this annotation correct ?”.

FIG. 5 depicts the system propagating annotations based on existing representations, and user Verification. The learnt representations are used to classify unlabeled content. User verification can be done for those examples in which the propagation has been done with the least confidence.

FIG. 6 depicts supervised learning of models and representations from user provided annotations. Once a set of labeled examples are available the system can learn representations of the user-defined semantic annotations through the process of supervised learning.

FIG. 7 shows active selection of examples for further disambiguation and corresponding update of representation. Since there is continuous user interaction, the representations can be updated interactively and sequentially after each new user interaction to further disambiguate the representation and strengthen the confidence in propagation.

FIGS. 8-13 show various screen shots from a video annotation tool in accordance with the present invention.

FIG. 14 shows a comparison of precision-recall curves showing classification performance for different active learning strategies with that using passive learning when only 10% and 90% of the training data were used.

FIG. 15 shows a comparison of detection to false alarm ratio for three active learning strategies and passive learning with progress the of iterations.

### DETAILED DESCRIPTION OF A PREFERRED EMBODIMENT OF THE INVENTION

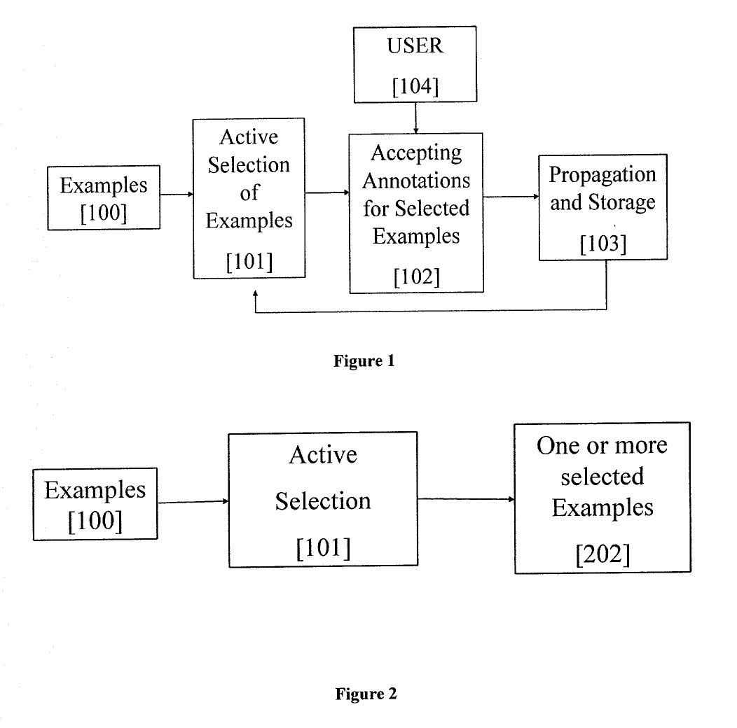

FIG. 1 is a functional block diagram showing an annotation system that actively selects examples to be annotated, accepts annotations for these examples from the user and propagates and stores these annotations. Examples [100] are first presented to the system, whereupon active selection of the examples is made [101] on the basis of maximum disambiguation—a process to be further described in the next paragraph. The next step [102] is the acceptance of the annotations from the user [104] for the examples selected by the system. Labels are propagated to yet unlabeled examples and stored [103] as a result of this process. The propagation and storage [103] then influences the next iteration of active selection [101]. The propagation of annotations [103] can be deterministic or probabilistic.

FIG. 2 illustrates the process of active selection [101] of examples [100] referred to previously. This may result in selection of one or more examples in [202] as shown in FIG. 2. The selection may be done deterministically or probabilistically. Selection may also be done using existing internal or external representations of the annotations in the vocabulary [500] (see FIG. 4).

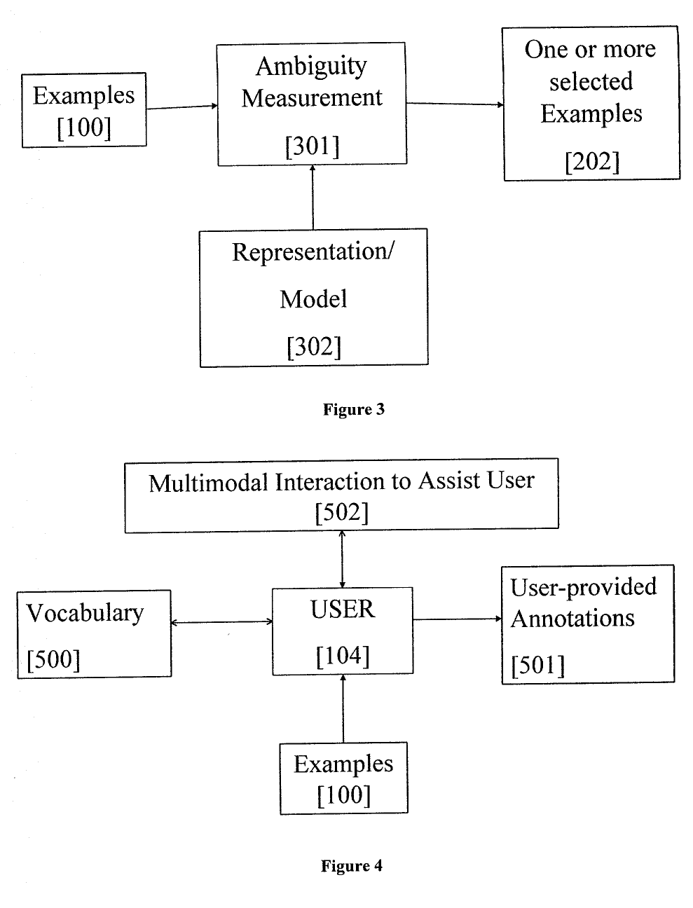

The quantitative measure of ambiguity or confidence in a label is a criterion that governs the selection process. FIG. 3 illustrates the use of ambiguity as a criterion for selection. The system minimizes the number of examples [100] that the user needs to annotate by selecting only those examples which are most ambiguous. Annotating these examples, thus, leads to maximal disambiguation and results in maximum confidence for the system to propagate the annotations automatically. The selected examples are, thus, the most “informative” examples in some sense. This ambiguity measurement may be accomplished by means of a number of mechanisms involving internal or external models [302], which may in turn be deterministic or probabilistic, such as the separating hyper-plane classifiers or variants thereof, neural network classifiers, parametric or nonparametric statistical model based classifiers, e.g., the gaussian mixture model classifiers or the many forms of bayesian networks.

The models may use a number of different feature representations [302], such as the color, shape, and texture for images and videos, or other standard or nonstandard features, e.g., the cepstral coefficient, zero crossings, etc., for audio. Still other feature types may be used depending on the nature and modality of the examples under consideration. Furthermore, the process of disambiguation may also make use of feature proximity and similarity criterion of choice.

The labels are selected from a fixed or dynamic vocabulary [500] of lexicons. These labels may be determined by the user, an administrator, or the system, and may consist of words, phrases, icons, etc.

FIG. 4 shows how the system accepts annotations from the vocabulary [500]. A user provides annotation from the vocabulary [500], which can be adaptively updated. Multimodal human computer interaction [502] may assist or facilitate the user in communicating with the system. The vocabulary [500] can be modified adaptively by the system and/or the user. Multimodal human-computer intelligent interaction [502] can reduce the burden of user interaction and can take the form of gestural action, e.g., facial movement, gaze, and finger pointing, as well as speech recognition.

The process of creation of input annotations [501] may include, but is not limited to, creating new annotations, deleting existing annotations, rejecting annotations proposed by the system, or modifying them.

The creation of annotations [501] and the update of the lexicon can be adaptive and dynamic and constrained by either the user or the system or both.

The use of models and representations in conjuction with unlabelled examples to propagate labels to unlabeled data is shown in FIG. 5. First representations [302] are obtained from the unlabeled data, which are then tested by means of existing models [302] built from training data. Based on the ambiguity measure mentioned earlier [301], the system suggests examples to be annotated, which are in turn verified by the user [801]. The verified annotations are then propagated [802], which can be further used as training data to update the models if desired. User verification can be performed for those examples in which the propagation has been done with the least confidence.

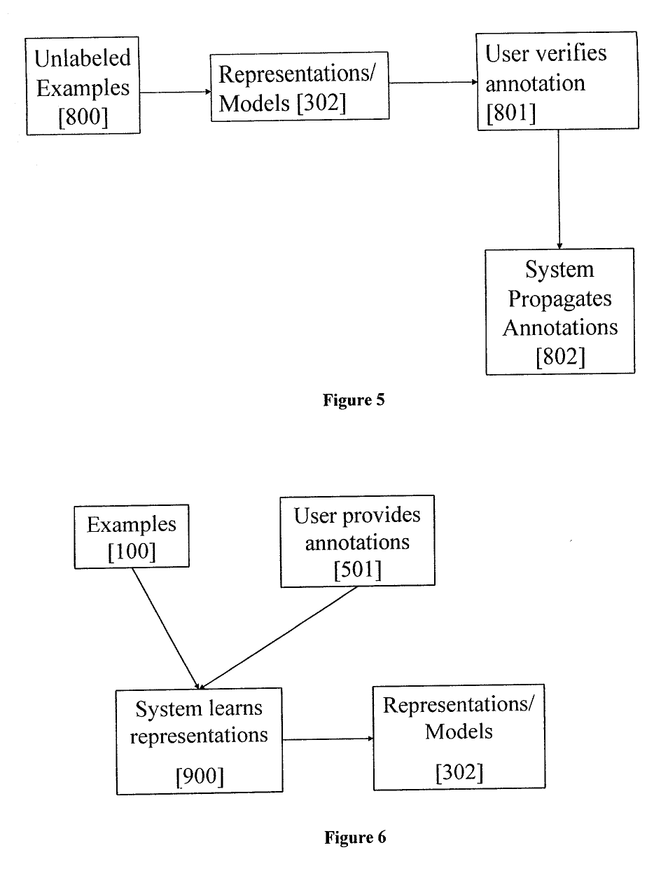

Once a set of labeled examples is available, the system can learn representations of the user-defined semantic annotations through the process of supervised learning. Supervised learning of models and representations from user provided annotations is shown in more detail in FIG. 6. Block [900] shows the learning of models and representations based on examples [100] and user provided annotations to produce the models. This step, among other aspects, can accomplish the initial startup set for models to allow the active annotation to get started.

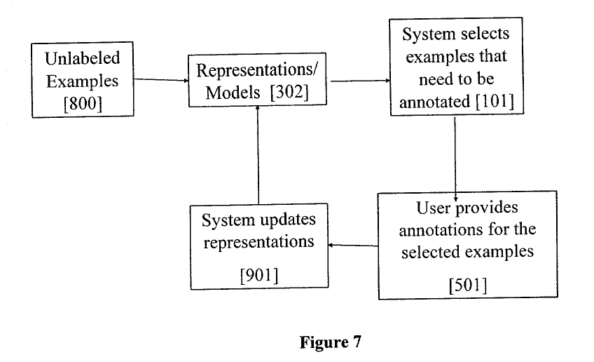

It is also possible to update the representation of the examples [302] in the process of active selection of examples for further disambiguation. This is illustrated in FIG. 7. Since there is continuous user interaction, the representations can be updated interactively and sequentially after each new user interaction to further disambiguate the representation and strengthen the confidence in propagation. The feedback loop [302] to [101] to [501] to [901] depicts this iterative update of the system representation just mentioned.

A preferred embodiment of the invention is now discussed in detail. The experiments used the TREC Video Corpus (http://www-nlpir.nist.gov/projects/t01v/), which is publicly available from the National Institute for Standards and Technologies. The experiments in the preferred embodiment will make use of a support vector machine (SVM) classifier as the preferred model [302] for generating system representations of annotated contents.

An SVM is a linear classifier that attempts to find a separating hyperplane that maximally separates two classes under consideration. A distinguishing feature of an SVM is that although it makes use of a linear hyperplane separator between the two classes, the hyperplane lives in a higher dimensional induced space obtained by nonlinearly transforming the feature space in which the original problem is posed. This “blowing up” of the dimension is achieved by a transformation of the feature space by proper choice of a Kernel function that allows inner products in the high dimensional induced space to be conveniently computed in the lower dimensional feature space in which the classification problem is originally posed. Commonly used examples of such (necessarily nonlinear) kernel functions are polynomial kernels, radial basis function, etc. The virtue of nonlinearly mapping the feature space to a higher dimensional space is that the generalization capability of the classifier is, thus, largely enhanced. This fact is crucial to the success of SVM classifiers with relatively small data-sets. The key idea here is that the true complexity of the problem is not necessarily in the “classical” dimension of the feature space, but in the so called “VC dimension,” which does not increase in transforming the space via properly chosen kernel function. Another useful fact is that the feature points near the decision boundary have a rather large influence on determining the position of the boundary. These so called “support vectors” turn out to be remarkably few in number and facilitate computation to a large degree. In the present context of active learning, these play an even more important role, because it is those unseen data that lie near the decision boundary and are, thus, potential candidates for new support vectors that are the most “informative” (or need to be disambiguated most [301]) and need to be labeled. Indeed, in the present application an SVM on the existing labeled data [100] is trained, and the next data point is selected [101] to be worthy of labeling only if it comes “close” to the separating hyperplane in the induced higher dimensional space. Several ways of measuring this closeness [301] to the separating hyperplane are possible. In what follows, the method will be described in more detail.

The TREC video corpus is divided into the training set and the testing set. The corpus consists of 47 sequences corresponding to 11 hours of MPEG video. These videos include documentaries from space explorations, US government agencies, river dams, wildlife conservation, and instructional videos. From the given content, a set of lexicons is defined for the video description and used for labeling the training set.

For each video sequence, first shot detection is performed to divide the video into multiple shots by using the CueVideo algorithm as taught by A. Amir, D. Ponceleon, B. Blanchard, D. Petkovic, S. Srinivasan, and G. Cohen in “Using Audio Time Scale Modification for Video Browsing,” Hawaii Int. Conf. on System Sciences, HICSS-33, Maui, January 2000. CueVideo segments an input video sequence into smaller units, by detecting cuts, dissolves, and fades. The 47 videos result in a total of 5882 detected shots. The next step is to define the lexicon for shot descriptions.

A video shot can fundamentally be described by three types of attributes. The first is the background surrounding of where the shot was captured by the camera, which is referred to as a site. The second attribute is the collection of significant subjects involved in the shot sequence, which is referred to as the key objects. The third attribute is the corresponding actions taken by some of the objects, which are referred to as the events. These three types of attributes define the vocabulary/lexicon [500] for the video content.

The vocabulary [500] for sites included indoors, outdoors, outer space, etc. Furthermore, each category is hierarchically sub-classified to comprise more specific scene descriptions. The simplified vocabulary [500] for the objects includes the following categories: animals, human, man-made structures, man-made objects, nature objects, graphics and text, transportation, and astronomy. In addition, each object category is subdivided into more specific object descriptions, i.e., “rockets,” “fire,” “flag,” “flower,” and “robots.” Some events of specific interest include “water skiing,” “boat sailing,” “person speaking,” “landing,” “take off or launch,” and “explosion.”

Using the defined vocabulary [500] for sites, objects, and events, the lexicon is imported into a video annotation tool in accordance with the invention, which describes and labels each video shot. The video annotation tool is described next.

The required inputs to the video annotation tool are a video sequence and its corresponding shot file. CueVideo segments an input video sequence into smaller units called video shots, where scene cuts, dissolves, and fades are detected.

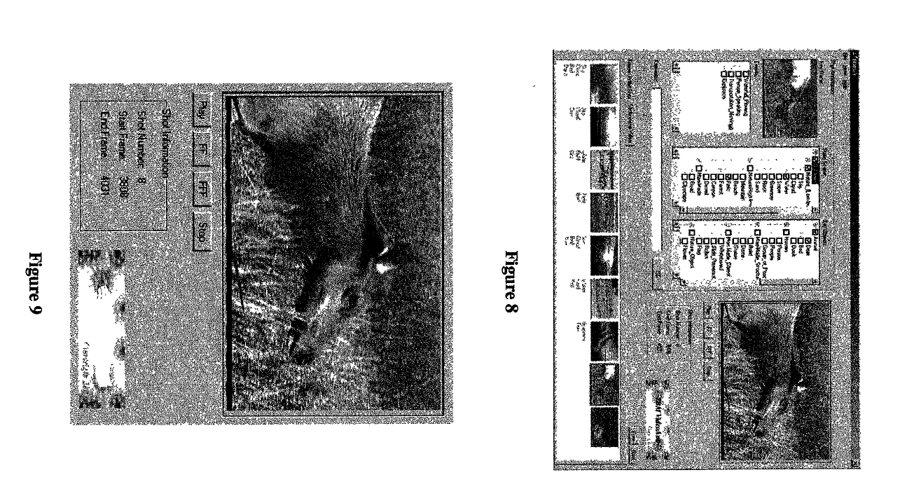

An overview of a graphical user interface for use with the invention is provided next. The video annotation tool is divided into four graphical sections as illustrated in FIG. 8. On the upper right-hand corner of the tool is the Video Playback window with shot information. On the upper left-hand corner of the tool is the Shot Annotation with a key frame image display. Located on the bottom portion of the tool are two different View Panels of the annotation preview. A fourth component, not shown in FIG. 8, is the Region Annotation pop-up window for specifying annotated regions. These four sections provide interactivity to the use of the annotation tool.

The Video Playback window on the upper right-hand corner displays the opened MPEG video sequence as show in FIG. 9. The four playback buttons directly below the video display window include:

Play—Play the video in normal real-time mode.

FF—Play the video in fast forward mode [display I ¹— and P² —frames].

FFF—Play the video in super fast forward [display only I-frames].

Stop—Pause the video in the current frame. ¹ An I-frame or intra-coded frame is a part of the MPEG bit stream that is compressed and transmitted without any use of neighboring frames. Most MPEG encoders transmit 2 I-frames every second. ² A P-frame or predictive frame is a part of the MPEG bit stream that is compressed using motion information computed using frames previous to this frame.

As the video is played back in the display window, the current shot information is given as well. The shot information includes the current shot number, the shot start frame, and the shot end frame.

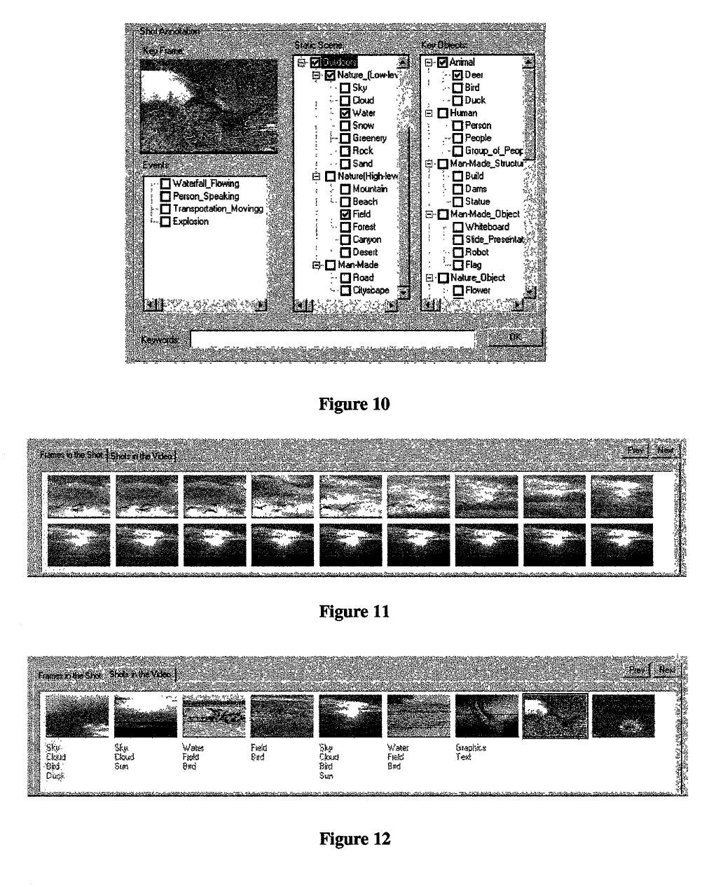

The Shot Annotation module on the upper left-hand corner displays the defined annotation descriptions and the key frame window as depicted in FIG. 10. As the video is displayed on the Video Playback, a key frame image of the current shot is displayed on the Key Frame window. In the shot annotation module, the annotation lexicon (i.e., the label) is also displayed. In this particular implementation, there are three types of lexicon in the vocabulary as follows:

Events—List the action events that can be used to annotate the shots.

Site—List the background sites that can be used to annotate the shots.

Objects—List the significant objects that are present in the shots.

These annotation descriptions have corresponding check boxes for the author to select [101], [202], [501]. Furthermore, there is a keywords box for customized annotations. Once the check boxes have been selected and the keywords typed, the author hits the OK button to advance to the next shot.

The Views Panel on the bottom displays two different previews of representative images of the video. They are:

Frames in the Shot—Display representative images of the current video shot.

Shots in the Video—Display representative images of the entire video sequence.

The Frames in the Shot view shows all the I-frames as representative images of the current shot as shown in FIG. 11. A maximum of 18 images can be displayed in this view. The Prev and Next buttons refresh the view panel to reflect the previous and next shot frames in the video sequence. Also, one can double-click on any of the representative images in the panel. This action designates the selected image to be the new key frame for this shot, and is respectively displayed on the Key Frame window. In this preview mode, if the author clicks the OK button on the Shot Annotation Window, then the video will stop playback of the current shot and advance to play the next shot.

The shots in the Video view show all the key frames of each shot as representative images over the entire video, as illustrated in FIG. 12. Below each shot's key frame is the annotated descriptions, if indeed they have already been provided. The author can peruse the entire video sequence in this view and examine the annotated and non-annotated shots. The Prev and Next buttons scroll the view panel horizontally to reflect the temporal video shot ordering. Also, one can double-click on any of the representative images in the panel. This action instantiates the selection of the corresponding shot, resulting in (1) the appropriate shot being displayed on the Video Playback window, (2) the simultaneous key frame being displayed on the Key Frame window, and (3) the corresponding checked descriptions on the Shot Annotation panels. In this preview mode, if the author clicks the OK button on the Shot Annotation Window then the video will FFF playback the current shot and advance to play the next shot in normal playback mode.

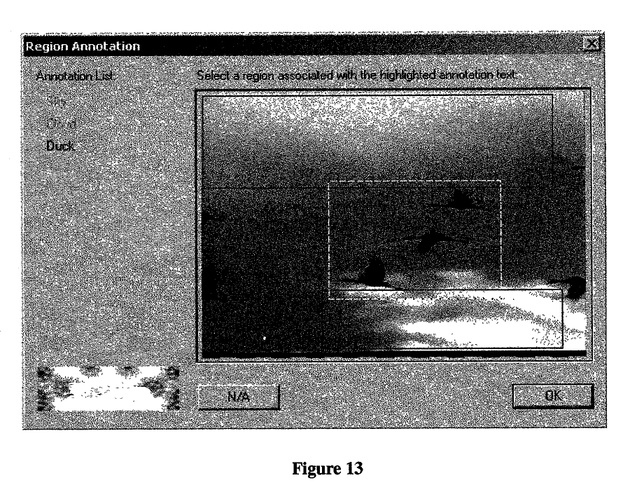

The Region Annotation pop-up window shown in FIG. 13 allows the author to associate a rectangular region with a labeled text annotation. After the text annotations are identified on the Shot Annotation window, each description can be associated with a corresponding region on the selected key frame of that shot. When the author finishes check marking the text annotations and clicks the OK button, then the Region Annotation window appears. On the left side of the Region Annotation window is a column of descriptions listed under Annotation List. On the right side is the display of the selected key frame for this shot along with some rectangular regions. For each description on the Annotation List, there may be one or no corresponding region on the key frame.

The descriptions under the Annotation List may be presented in one of four colors:

1. Black—the corresponding description has not been region annotated.

2. Blue—the corresponding description is currently selected.

3. Gray—the corresponding description has been labeled with a rectangular region.

4. Red—the corresponding description has no applicable region. (i.e., when you N/A is clicked)

The regions on the Key Frame image may be presented in one of two colors:

a) Blue—the region is associated with one of the not-current descriptions (i.e., the description in Gray color).

b) White—the region is associated with the currently selected description (i.e., the description in Blue color).

When the Region Annotation window pops up, the first description on the Annotation List is selected and highlighted in Blue, while the other descriptions are colored Black. The system then waits for the author to provide a region on the image where the description appears by clicking-and-dragging a rectangular bounding box around the area of interest. Right after the region is designated for one description, the system advances to the next description on the list. If there is no applicable region on the key frame image, click the N/A button, and the corresponding description will appear in Red. At any time, the author can click any description on the Annotation List to make that selection current. Thus the description text will appear in Blue and the corresponding region, if any, will appear in White. Furthermore, this action allows the author to modify the current region of any description at any time.

Some simulation experiments to demonstrate the effectiveness of SVM-based active learning algorithm [900] on the video-TREC database is reported next. Of the many labeled examples that are available via the use of the video annotation tool on the video-TREC database, only results on a specific label set, namely, on indoor-outdoor classification are dealt with here. Approximately 10,000 examples were made use of. To begin with, approximately 1% of the data were chosen and their labels, as provided by human annotators, were accepted. Subsequently, the support vector classifier is then built on the basis of this annotated data-set and new unseen examples are presented to the classifier in steps. Each unseen example is classified by the SVM classifier and the confidence [301] in classification is taken to be inversely proportional to the distance of the new feature from the separating hyperplane in the induced higher dimensional feature space. If this distance is less than a specified threshold then the new sample is included in the training set.

The following three different selection strategies corresponding to three different ambiguity measurements [302] were adopted:

1. In the first strategy, the absolute distance from the hyperplane is measured. These are referred to as experiments of type-I.

2. In the second strategy, absolute distances were considered, but one selects points to be included in the training set only if the point is classified negatively—the rationale for this being that one wishes to balance the lack of positively labeled data in the training set. These are referred to as experiments of type-II.

3. In the third strategy, one rescales ratio of distance of points classified negatively to points classified positively by a factor 2:1 before making a decision whether to select a point or not. The rationale for this ratio again comes from the fact that there are approximately twice as many negatively labeled examples compared to the positively labeled examples. These are referred to as experiments of type-III.

The SVM classifier is retrained after every decision to include a new example in the training set. Note that if the example is not selected then the uncertainty associated with its classification is low and its label can be automatically propagated. Iterative updates of the classifier can proceed in this manner until a desirable performance level is reached.

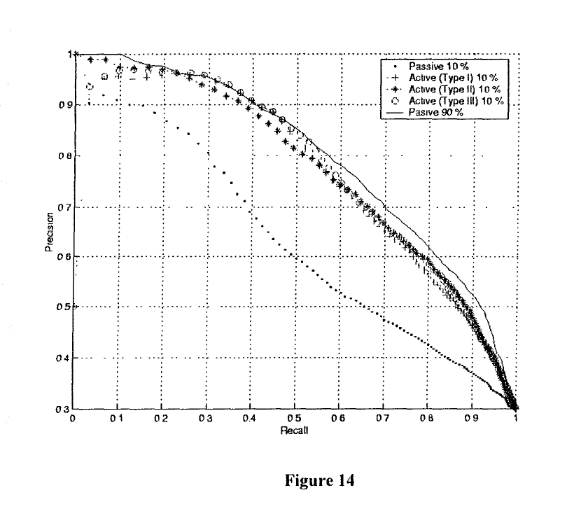

The precision recall curves for retrieval performance achieved by the classifiers so trained are shown in FIG. 14. The lowermost dotted curve and uppermost continuous curve show the performance of the classifier when only 10% and 90% of the labeled training data are respectively chosen for passive supervised training. These two curves serve the purpose of comparing the effectiveness of active (semi-supervised) learning as against passive (supervised) learning. The remaining three curves refer to precision recall behavior of the classifiers trained with 10% data by adopting active learning strategies of types I, II and III. It is remarkable that with all three training strategies active learning with only 10% data shows performance almost as good as passive training with 90% data and much better than passive training with 10% data.

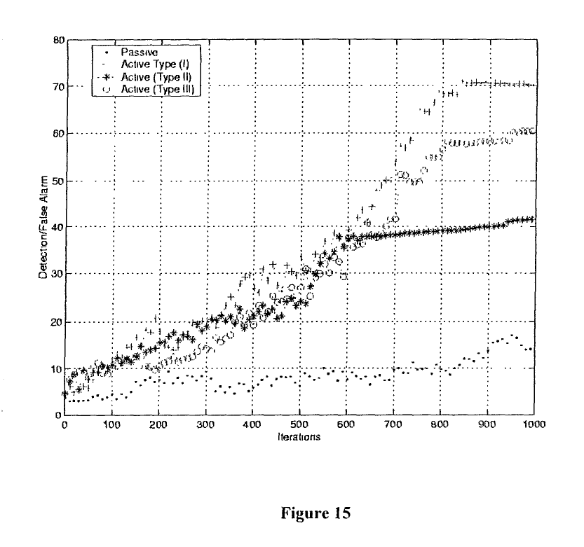

The ROC curves in FIG. 15 show the detection to false alarm ratio as another measure of retrieval performance with progress of iterations. The results are in conformity with those in FIG. 15. Remarkably improved detection to false alarm ratio for all three types of active learning compared to passive learning is again observed.

While the present invention has been described in the context of a fully functioning data processing system, those of ordinary skill in the art will appreciate that the processes of the present invention are capable of being distributed in the form of a computer readable medium of instructions and a variety of other forms, and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. Method for generating persistent annotations of multimedia content, comprising one or more repetitions of the following steps:
actively selecting examples of multimedia content to be annotated by a user;
accepting input annotations from said user for said selected examples;
propagating said input annotations to other instances of multimedia content; and
storing said input annotations and said propagated annotations.

2. The method of claim 1, wherein the step of actively selecting is performed using a selection technique selected from the group consisting of: deterministic and probabilistic.

3. The method of claim 2, wherein the step of actively selecting, which is performed deterministically or probabilistically, is based on explicit models and feature proximity/similarity measures, and returns one or more examples of multimedia content to be annotated.

4. The method of claim 2, wherein the step of actively selecting, which is performed deterministically or probabilistically, is based on implicit models and feature proximity/similarity measures, and returns one or more examples of multimedia content to be annotated.

5. The method of claim 1, wherein an optimization criterion for active selection includes one or more criteria selected from the group consisting of: maximizing disambiguation, information measures, and confidence.

6. The method of claim 1, wherein the multimedia content comprises one or more types selected from the group consisting of: images, audio, video, graphics, text, multimedia, Web pages, time series data, surveillance data, sensor data, relational data, and XML data.

7. The method of claim 1, wherein the input annotations are created by a user with reference to a vocabulary.

8. The method of claim 7, wherein the vocabulary contains one or more items selected from the group consisting of: terms, concepts, labels, and annotations.

9. The method of claim 1, wherein the process of creating input annotations by the user involves multimodal interaction with the user using graphical, textual, and/or speech interface.

10. The method of claim 1, wherein the input annotations are created by means of steps selected from the group consisting of: creating new annotations, deleting existing annotations, rejecting proposed annotations, and modifying annotations.

11. The method of claim 7, wherein the vocabulary is adaptively or dynamically organized and/or limited by the system or the user.

12. The method of claim 9, wherein the multimodal interaction involves speech recognition, gaze detection, finger pointing, expression detection, and/or effective computing methods for sensing a user's state.

13. The method of claim 1, wherein the determination of the propagation of annotations is made deterministically or probabilistically and on the use of models for each annotation or for joint annotations.

14. The method of claim 2, wherein the models are created or learned automatically or semi-automatically and/or are updated adaptively from interaction with the user.

15. The method of claim 2, wherein the models are based on nearest neighbor voting or variants, parametric or statistical models, expert systems, rule-based systems, or hybrid techniques.

16. System for generating persistent annotations of multimedia content, comprising:
means for actively selecting examples of multimedia content to be annotated by a user;
means for accepting input annotations from said user for said selected examples;
means for propagating said input annotations to other instances of multimedia content; and
means for storing said input annotations and said propagated annotations.

17. The system of claim 16 wherein the means for actively selecting uses a selection technique selected from the group consisting of: deterministic and probabilistic.

18. The system of claim 17, wherein the means for actively selecting, which uses a deterministic or probabilistic technique, is based on explicit models and feature proximity/similarity measures, and returns one or more examples of multimedia content to be annotated.

19. The system of claim 17, wherein the means for actively selecting, which uses a deterministic or probabilistic technique, is based on implicit models and feature proximity/similarity measures, and returns one or more examples of multimedia content to be annotated.

20. The system of claim 16, wherein an optimization criterion for active selection includes one or more criteria selected from the group consisting of: maximizing disambiguation, information measures, and confidence.

21. The system of claim 16, wherein the multimedia content comprises one or more types selected from the group consisting of: images, audio, video, graphics, text, multimedia, Web pages, time series data, surveillance data, sensor data, relational data, and XML data.

22. A computer program product in a computer readable medium for generating persistent annotations of multimedia content, the computer program product comprising instructions for performing one or more repetitions of the following steps:
actively selecting of examples of multimedia content to be annotated by a user;
accepting input annotations from said user for said selected examples;
propagating said input annotations to other instances of multimedia content; and
storing said input annotations and said propagated annotations.
